(19) United States
(12) Patent Application Publication
(10) Pub. No.: US 2021/0204352 A1
(43) Pub. Date: Jul. 1, 2021

(54) DATA TRANSMISSION METHOD, TRANSMITTING END DEVICE AND RECEIVING END DEVICE

(71) Applicant: GUANGDONG OPPO MOBILE TELECOMMUNICATIONS CORP., LTD., Dongguan (CN)

(72) Inventors: QIANXI LU, Dongguan (CN); ZHENSHAN ZHAO, Dongguan (CN); HUEI-MING LIN, Taiwan (CN)

(21) Appl. No.: 17/202,814

(22) Filed: Mar. 16, 2021

Related U.S. Application Data
(63) Continuation of application No. PCT/CN2018/108449, filed on Sep. 28, 2018.

(51) Int. Cl. H04W 76/27; H04L 12/741

(52) U.S. Cl. CPC H04W 76/27; H04L 45/74

(57) ABSTRACT

Provided are a data transmission method, a transmitting end device, a receiving end device, a communication device, a chip, a computer-readable storage medium, a computer program product and a computer program, which can realize the reliable transmission of repeated data in an Internet of Vehicles system. The method includes: a transmitting end device sending multiple radio link control protocol data units (RLC PDUs) to a receiving end device, wherein a first packet header associated with at least one of the multiple RLC PDUs comprises an indication field, and the indication field is used to indicate a radio bearer corresponding to the RLC PDU; and at least two RLC PDUs in the multiple RLC PDUs correspond to a first communication system and a second communication system, respectively.

### CROSS-REFERENCE TO RELATED APPLICATION

The present application is a continuation application of International PCT Application No. PCT/CN2018/108449, filed on Sep. 28, 2018, the entire content of which is hereby incorporated by reference.

### TECHNICAL FIELD

The present disclosure relates to a communication field, and more particularly, to a data transmission method, a transmitting end device, a receiving end device, a communication device, a chip, a computer readable storage medium, a computer program product and a computer program.

### BACKGROUND

A vehicle networking or a Vehicle-to-Everything (V2X) communication system is a SideLink (SL) transmission technology based on a Device to Device (D2D) communication. Different from a traditional Long Term Evolution (LTE) system in which communication data is received or transmitted through a base station, the vehicle networking system uses a terminal-to-terminal direct communication, so it has a higher spectrum efficiency and a lower transmission delay.

In the vehicle networking system, a requirement for a reliability of data transmission is high, and how to realize reliable transmission of data is an urgent problem to be solved.

### SUMMARY

Implementations of the present disclosure provide a data transmission method, a transmitting end device, a receiving end device, a communication device, a chip, a computer readable storage medium, a computer program product and a computer program.

In a first aspect, an implementation of the present disclosure provides a method for data transmission, including:

sending, by a transmitting end device, multiple radio link control protocol data units (RLC PDU) to a receiving end device;

wherein a first message header associated with at least one RLC PDU in the multiple RLC PDUs includes an indication field, the indication field is used for indicating a radio bearer corresponding to the RLC PDU; and

at least two RLC PDUs in the multiple RLC PDUs correspond to a first communication system and a second communication system respectively.

In a second aspect, an implementation of the present disclosure provides a method for data transmission, including:

receiving, by a receiving end device, multiple radio link control protocol data units (RLC PDU) sent by a transmitting end device; and

determining, by the receiving end device, a radio bearer corresponding to each RLC PDU in the multiple RLC PDUs according to a corresponding relationship between a logical channel and a radio bearer;

wherein a first message header associated with at least one RLC PDU in the multiple RLC PDUs includes an indication field, wherein the indication field is used for indicating a radio bearer corresponding to the RLC PDU, and

at least two RLC PDUs in the multiple RLC PDUs correspond to a first communication system and a second communication system respectively.

In a third aspect, an implementation of the present disclosure provides a transmitting end device, including:

a sending unit, configured to send multiple radio link control protocol data units (RLC PDU) to a receiving terminal device;

wherein a first message header associated with at least one RLC PDU in the multiple RLC PDUs includes an indication field, wherein the indication field is used for indicating a radio bearer corresponding to the RLC PDU; and

at least two RLC PDUs in the multiple RLC PDUs correspond to a first communication system and a second communication system respectively.

In a fourth aspect, an implementation of the present disclosure provides a receiving end device, including:

a receiving unit, configured to receive multiple radio link control protocol data units (RLC PDU) sent by a transmitting end device; and

a processing unit, configured to determine a radio bearer corresponding to each RLC PDU in the multiple RLC PDUs according to a corresponding relationship between a logical channel and a radio bearer;

wherein a first message header associated with at least one RLC PDU in the multiple RLC PDUs includes an indication field, wherein the indication field is used for indicating a radio bearer corresponding to the RLC PDU, and

at least two RLC PDUs in the multiple RLC PDUs correspond to a first communication system and a second communication system respectively.

In a fifth aspect, an implementation of the present disclosure provides a communication device, including a processor and a memory. The memory is configured to store a computer program, and the processor is configured to call and run the computer program stored in the memory to execute a method in above first aspect or second aspect or various implementation modes thereof.

In a sixth aspect, there is provided a chip, configured to implement a method in any one aspect of above first aspect to second aspect or various implementation modes thereof.

Specifically, the chip includes: a processor, configured to call and run a computer program from a memory, causing a device on which the chip is installed to execute a method in any one aspect of above first aspect to second aspect or various implementation modes thereof.

According to a seventh aspect, there is provided a computer-readable storage medium, configured to store a computer program, wherein the computer program causes a computer to execute a method in any one aspect of the above first aspect to second aspect or various implementations thereof.

According to an eighth aspect, there is provided a computer program product including computer program instructions, wherein the computer program instructions cause a computer to execute a method in any one aspect of the above first aspect to second aspect or various implementation modes thereof.

According to a ninth aspect, there is provided a computer program which, when run on a computer, causes the computer to execute a method in any one aspect of above first aspect to second aspect or various implementation modes thereof.

Accord to a solution provided by an implementation of the present disclosure, when a transmitting end device sends multiple RLC PDUs, an indication field indicating a radio bearer corresponding to a current RLC PDU may be included in a first message header of at least one RLC PDU in the multiple RLC PDUs. Therefore, a receiving end device may determine a radio bearer corresponding to each RLC PDU in the multiple RLC PDUs, thereby realizing reliable transmission of data.

### BRIEF DESCRIPTION OF DRAWINGS

FIG. 1 is a schematic diagram of an application scenario of an implementation of the present disclosure.

FIG. 2 is a schematic diagram of another application scenario of an implementation of the present disclosure.

FIG. 3A is schematic diagram one of performing data transmission through a carrier aggregation in an implementation of the present disclosure.

FIG. 3B is schematic diagram two of performing data transmission through a carrier aggregation in an implementation of the present disclosure.

FIG. 4 is a schematic flow chart of a method for data transmission according to an implementation of the present disclosure.

FIG. 5 is a schematic flow chart of another method for data transmission according to an implementation of the present disclosure.

FIG. 6 is a schematic block diagram of a transmitting end device according to an implementation of the present disclosure.

FIG. 7 is a schematic block diagram of a receiving end device according to an implementation of the present disclosure.

FIG. 8 shows a schematic block diagram of a communication device.

FIG. 9 is a schematic structural diagram of a system chip according to an implementation of the present disclosure.

FIG. 10 is a schematic diagram of two frame structures in an implementation of the present disclosure.

### DETAILED DESCRIPTION

Technical solutions in implementations of the present disclosure will be clearly and completely described below with reference to drawings in implementations of the present disclosure.

It should be understood that the technical solution of implementations of the present disclosure may be applied to a vehicle networking system, wherein the vehicle networking system may be based on various communication systems, for example, a vehicle networking system based on LTE-D2D. Different from a mode in which communication data between terminals is received or transmitted through a network device (for example, a base station) in a traditional LTE system, a vehicle networking system adopts a D2D direct communication mode, thus having a higher spectral efficiency and a lower transmission delay.

Optionally, a communication system on which the vehicle networking system is based may be a Global System of Mobile communication (GSM) system, a Code Division Multiple Access (CDMA) system, a Wideband Code Division Multiple Access (WCDMA) system, a General Packet Radio Service (GPRS) system, an LTE system, an LTE Frequency Division Duplex (FDD) system, an LTE Time Division Duplex (TDD) system, a Universal Mobile Telecommunication System (UMTS) system, a Worldwide Interoperability for Microwave Access (WiMAX) communication system, a New Radio (NR) or future 5G system, etc.

A terminal device in implementations of the present disclosure may be a vehicle-mounted terminal device, or may be a terminal device in a future 5G network or a terminal device in a future evolved Public Land Mobile Network (PLMN) etc., and this is not limited in implementations of the present disclosure.

Various implementations are described with reference to a network device in the present disclosure. A network device in implementations of the present disclosure may be a device for communicating with a terminal device, a Base Transceiver station (BTS) in GSM or CDMA, a NodeB (NB) in a WCDMA system, an evolutional NodeB (eNB or eNodeB) in an LTE system, or a wireless controller in a scenario of a Cloud Radio Access Network (CRAN). Or the network device may be a relay station, an access point, an vehicle-mounted device, a wearable device, a network device in a future 5G network, or a network device in a future evolved Public Land Mobile Network (PLMN), etc., which is not limited in implementations of the present disclosure.

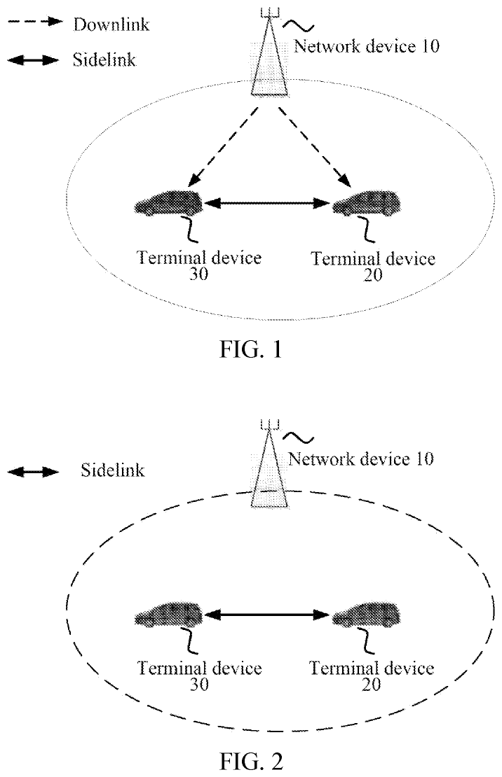

FIG. 1 and FIG. 2 are schematic diagrams of application scenarios of implementations of the present disclosure. FIG. 1 illustratively shows one network device and two terminal devices. Optionally, a wireless communication system in implementations of the present disclosure may include multiple network devices 10 and a coverage area of each network device 10 may include other number of terminal devices, which is not limited in implementations of the present disclosure. In addition, the wireless communication system may include other network entities, such as a Mobile Management Entity (MME), a Serving Gateway (S-GW), a Packet Data Network Gateway (P-GW), and implementations of the present disclosure are not limited thereto.

Specifically, a terminal device 20 and a terminal device 30 may communicate through a D2D communication mode. During a D2D communication, the terminal device 20 and the terminal device 30 directly communicate through a D2D link, that is, a Sidelink (SL). For example, as shown in FIG. 1 or FIG. 2, the terminal device 20 and the terminal device 30 communicate directly through the sidelink. In FIG. 1, the terminal device 20 and the terminal device 30 communicate through the sidelink, and their transmission resources are allocated by the network device 10. In FIG. 2, the terminal device 20 and the terminal device 30 communicate through a sidelink, and their transmission resources are independently selected by the terminal device, and the network device does not need to allocate the transmission resources.

A D2D communication may refer to a vehicle to vehicle (V2V) communication or a Vehicle to Everything (V2X) communication. In the V2X communication, X may generally refer to any device with wireless receiving and transmitting capabilities, such as but not limited to a wireless device that moves slowly, a vehicle-mounted device that moves fast, or a network control node with wireless transmitting and receiving capabilities, etc. It should be understood that implementations of the present disclosure are mainly applied to V2X communication scenarios, but may also be applied to any other D2D communication scenarios, and this is not limited in implementations of the present disclosure.

In a vehicle networking system, there may be two types of terminal devices, which are, a terminal device with a sensing capability such as a Vehicle User Equipment (VUE) or a Pedestrian User device (PUE), and a terminal device without a sensing capability such as a PUE. A VUE has a higher processing capability and is usually powered by a battery in a car. While a PUE has a lower processing capability and reducing a power consumption is a major factor to be considered for the PUE. Therefore, in existing vehicle networking systems, a VUE is considered to have a full receiving capability and a full sensing capability, while a PUE is considered to have partial or no receiving and sensing capabilities. If a PUE has partial sensing capability, a sensing method similar to that of a VUE may be adopted for a selection of resources of the PUE, and a selection of available resources may be carried out on a part of resources that may be sensed. If the PUE does not have a sensing capability, the PUE randomly selects transmission resources in a resource pool.

In Release-14 of a 3GPP protocol, two transmission modes, namely transmission mode 3 (mode 3) and transmission mode 4 (mode 4), are defined. Transmission resources of a terminal device using transmission mode 3 are allocated by a base station. The terminal device performs data transmission on a sidelink according to resources allocated by the base station. The base station may allocate resources to the terminal device for a single transmission or allocate resources to the terminal device for a semi-static transmission. A terminal device using transmission mode 4 transmits the data by means of sensing and reservation if it has the sensing capability, and randomly selects transmission resources from the resource pool if it does not have the sensing capability. The terminal device with the sensing capability obtains an available resource set in the resource pool by sensing, and randomly selects a resource from the set for data transmission. Since a service in the vehicle networking system has a periodic characteristic, the terminal device usually adopts a semi-static transmission mode, that is, after selecting a transmission resource, the terminal will continuously use the resource in multiple transmission periods, thus reducing probabilities of resource re-selection and resource conflict. The terminal device carries information for reserving a next transmission resource in control information for a current transmission, so that other terminal device may determine whether the resource is reserved and used by the terminal device by detecting the control information of the terminal device, thus achieving a purpose of reducing resource conflicts.

Since resources of transmission mode 3 are scheduled by the base station, and a resource pool of transmission mode 4 is preconfigured or configured by the base station, there will be no resource pool overlapping between them, that is, resource pools corresponding to transmission mode 3 and transmission mode 4 respectively are separated or not overlapped. A terminal device using mode 3 transmits data on time-frequency resources in a resource pool supporting mode 3, while a terminal device using mode 4 transmits data on time-frequency resources in a resource pool supporting mode 4.

For a terminal device supporting a communication protocol of the new Release-15 of 3GPP protocol, it also supports two kinds of transmission modes, such as above transmission mode 3 and transmission mode 4. When a terminal device of Release-15 and a terminal device of Release-14 perform data transmission together in a communication system, for a terminal device with a sensing capability, resources may be selected through resource sensing, while for a terminal device without a sensing capability, interference with data transmission of other terminal device will inevitably occur. Since a terminal device using transmission mode 3 is connected with a base station and its transmission resources are allocated by the base station, when a terminal device using transmission mode 3 and a terminal device using transmission mode 4 coexist, it is more necessary to protect a transmission reliability of the terminal device using transmission mode 3.

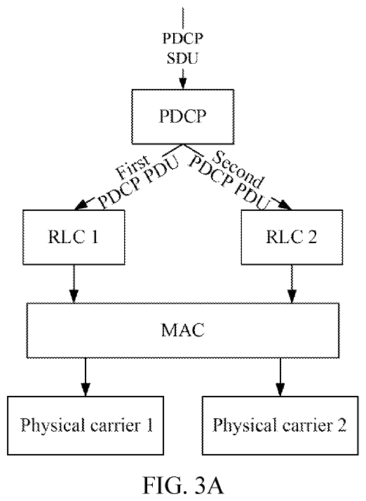

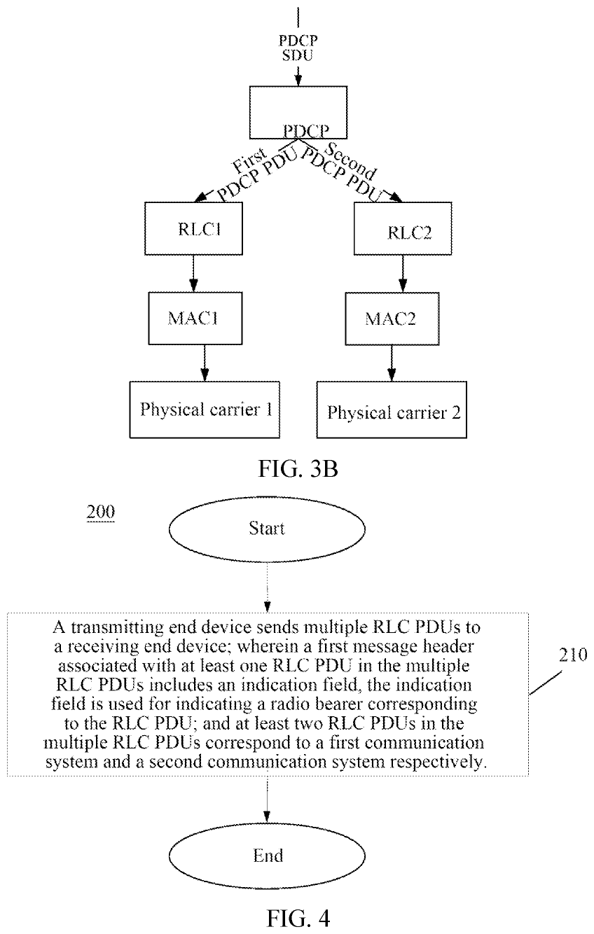

Optionally, as shown in FIG. 3, in a vehicle networking system, a terminal device may send same PDCP layer data to a network device or other terminal devices through two carriers based on a carrier aggregation. Specifically, one PDCP entity is bound to two RLC entities. The terminal device may transmit PDUs in two ways, i.e. duplication or non-duplication. The way of duplication may be as shown in FIG. 3A, and a first PDCP PDU to be sent is duplicated to obtain a second PDCP PDU. The terminal device sends the first PDCP PDU to one RLC entity of the two RLC entities, RLC 1, and sends the second PDCP PDU to the other RLC entity of the two RLC entities, RLC 2. The two RLC entities process the received PDCP PDUs respectively, and send the first PDCP PDU and the second PDCP PDU to the network device or other terminal device through two different carriers.

Adopting a transmission way of the non-duplication may refer to FIG. 3B. PDCP SDUs to be sent are divided to obtain different first PDCP PDUs and second PDCP PDUs. For example, when the PDCP PDUs to be sent are PDUs 1, 2, 3, 4 and 5, PDUs 1, 2 and 3 may be sent in the first PDCP PDU, and PDUs 4 and 5 may be sent in the second PDCP PDU. Or, PDUs 1, 3 and 5 may be sent in the first PDCP PDU, and PDUs 2 and 4 may be sent in the second PDCP PDU. The terminal device sends the first PDCP PDU to one RLC entity of the two RLC entities, RLC 1, and sends the second PDCP PDU to the other RLC entity of the two RLC entities, RLC2. The two RLC entities process received PDCP PDUs respectively, and transmit them to carrier 1 and carrier 2 respectively through two different MACs to and send the first PDCP PDU and the second PDCP PDU to the network device or other terminal device.

It should be understood that when receiving data transmitted by the network device or other terminal device, the terminal device may perform a reverse process of the data transmission process as shown in FIG. 3A or FIG. 3B.

In addition, various aspects or features of the present disclosure may be implemented as methods, apparatuses, or articles of manufacture using standard programming and/or engineering techniques. a term “article of manufacture” used in the present disclosure encompasses a computer program accessible from any computer-readable device, carrier, or medium. For example, the computer-readable medium may include, but is not limited to, a magnetic storage device (such as a hard disk, a floppy disk, or a magnetic tape, etc.), a disk (such as a Compact Disc (CD), a Digital Versatile Disc (DVD), etc.), a smart card and a flash storage device (such as an Erasable Programmable Read-Only Storage (EPROM), card, stick or key drive). In addition, various storage media described herein may represent one or more devices and/or other machine-readable medium for storing information. A term “machine-readable medium” may include, but is not limited to, various media capable of storing, containing, and/or carrying instructions and/or data.

It should be understood that terms “system” and “network” are often used interchangeably in this document. A term “and/or” in this document is merely an association relationship describing associated objects, indicating that there may be three relationships, for example, A and/or B may indicate three cases: A alone, A and B, and B alone. In addition, a symbol “/” in this document generally indicates that objects before and after the symbol “/” have an “or” relationship.

FIG. 4 is a schematic flow chart of a method for data transmission 200 according to an implementation of the present disclosure. As shown in FIG. 4, the method 200 may be executed by a transmitting end device, wherein the transmitting end device may be a terminal device as shown in FIG. 1 or FIG. 2, and the terminal device may execute data transmission as shown in FIG. 3. A receiving end device in the method 200 may be a network device as shown in FIG. 1 or a terminal device as shown in FIG. 1 or FIG. 2, and the method 200 may be applied to a vehicle networking system. The method 200 includes following contents.

In 210, a transmitting end device sends multiple RLC PDUs to a receiving end device.

A first message header associated with at least one RLC PDU in the multiple RLC PDUs includes an indication field, wherein the indication field is used for indicating a radio bearer corresponding to the RLC PDU.

At least two RLC PDUs in the multiple RLC PDUs correspond to a first communication system and a second communication system respectively.

In the implementation, the transmitting end device may send at least two RLC PDUs when performing a data duplication service through a carrier aggregation. It may also send at least two RLC PDUs when not performing the data duplication service.

Firstly, a processing mode when transmitting a non-data duplication service is introduced.

At least two RLC PDUs in the multiple RLC PDUs correspond to different transmission formats when the data duplication service is not transmitted, wherein the at least two RLC PDUs correspond to a same radio bearer.

Furthermore, referring to FIG. 3B, when the data duplication service is not transmitted, contents transmitted by the at least two RLC PDUs are also different. For example, the contents transmitted by the at least two RLC PDUs may correspond to serial numbers in different PDCP SDUs. For example, SDU 1 and SDU 3 are the first PDCP PDU, and SDU 2 and SDU 4 are the second PDCP PDU, which are sent to two RLC entities respectively after passing through an RLC layer. The two RLC entities process the received PDCP PDUs respectively, and transmit them to carrier 1 and carrier 2 through two different MACs to send the first RLC PDU and the second RLC PDU to a network device or other terminal device. It should also be understood that a mode for separately transmitting PDCP PDUs to be sent provided in the implementation is only an example, and other division modes may be adopted in actual processing, which are all within a protection scope of the implementation.

Further, the first communication system and the second communication system aforementioned are two different communication systems, which may be a long term evolution LTE system and a new wireless NR system, respectively. Or, they may be other different communication systems, which are not exhaustive here.

Accordingly, when the first communication system and the second communication system are LTE and NR respectively, the different transmission formats correspond to transmission formats of LTE and NR respectively. That is, when non-duplicated RLC PDUs are transmitted, transmission formats corresponding to respective communication systems are adopted for the transmission.

On this basis, when transmitting the data non-duplication service, the transmitting end device needs to indicate a radio bearer corresponding to a current RLC PDU through the indication field included in the first message header associated with the RLC PDU.

Optionally, the indication field includes an Identity (ID) of a radio bearer corresponding to a PDCP corresponding to the current RLC PDU.

Optionally, the indication field may also include a logical channel identity.

There may be another mode. A logical channel identity (LCID) and a reserved bit are included in the indication field. Two different logical channels serving a same bearer may be distinguished by assignments of different reserved bits. The specific way is as follows.

Carrier 1: MAC SDU A is transmitted for logical channel A, the reserved bit is set=0, and LCID=X; for example, X=00001.

Carrier 2: another MAC SDU B is transmitted for logical channel B, its reserved bit is set=1, and LCID=X; also, X=00001.

It should be noted that the aforementioned logical channels A and B serve a same PDCP entity, but perform a PDCP non-duplication operation. By using the above method, a reserved LCID space may be reserved.

Optionally, the first message header associated with the at least one RLC PDU is:

a first message header corresponding to the at least one RLC PDU, or a first message header contained in the at least one RLC PDU.

The first message header may be an RLC message header.

That is to say, there are two corresponding ways between an RLC PCU and a first message header. One way is that there is a correspondence between an RLC PDU and a first message header, under the correspondence, the RLC PDU may not contain an RLC message header, but the RLC message header is included outside the RLC PDU. In the case, the RLC message header may constitute a MAC sub-header. In this way, the RLC PDU, the RLC message header constituting the MAC sub-header, and the MAC header, may be used to jointly constitute a data unit of a MAC layer.

In another way, the RLC PDU contains the first message header. In this way, the RLC PDU constitutes the data unit of the MAC layer. The data unit of the MAC layer may be a MAC PDU.

Optionally, at least two RLC PDUs in the multiple RLC PDUs correspond to different logical channels respectively, and the at least two RLC PDUs correspond to the same radio bearer.

Further, a processing mode when transmitting the data duplication service is as follows.

At least two RLC PDUs in the multiple RLC PDUs correspond to different transmission formats when the data duplication service is not transmitted. The at least two RLC PDUs correspond to the same radio bearer.

Optionally, when the transmitting end device performs the data duplication service through the carrier aggregation, it needs to indicate the radio bearer corresponding to the current RLC PDU through the indication field.

Optionally, the indication field includes the Identity (ID) of the radio bearer corresponding to the PDCP corresponding to the current RLC PDU.

Optionally, the indication field includes a logical channel identity.

There may be a further way. A logical channel identity (LCID) and a reserved bit are included in the field. Two different logical channels serving the same bearer may be distinguished by assignments of different reserved bits. The specific way is as follows.

Carrier 1: MAC SDU A is transmitted for logical channel A, the reserved bit is set=0, and LCID=X; for example, X=00001.

Carrier 2: another MAC SDU B (which may be understood as a duplicated SDU) is transmitted for logical channel B, its reserved bit is set=1 and LCID=X; also, X=00001.

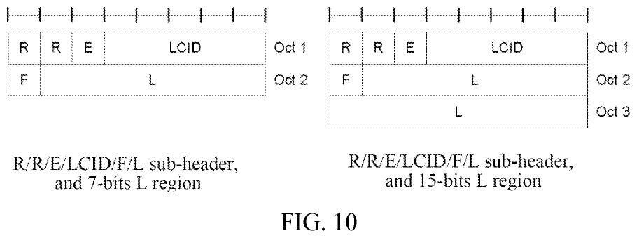

It should be pointed out that the aforementioned logical channels A and B serve a same PDCP entity and realize a PDCP duplication operation. By using the above method, a reserved LCID space may be reserved, and a duplication function may be extended to PC5-S information. Referring to FIG. 10, R represents a position of the reserved bit, one of which is a frame structure containing a 7 bitsL region, and another is a frame structure containing a 15 bitsL region, which will not be described in detail here.

Optionally, the first message header associated with the at least one RLC PDU is:

a first message header corresponding to the at least one RLC PDU;

or a first message header contained in the at least one RLC PDU.

The first message header may be an RLC message header.

That is to say, there are two corresponding ways between an RLC PCU and a first message header. One way is that there is a correspondence between an RLC PDU and a first message header, under the correspondence, the RLC PDU may not contain the RLC message header, but the RLC message header is included outside the RLC PDU. In this case, the RLC message header may constitute a MAC sub-header. In this way, the RLC PDU, the RLC message header constituting MAC sub-header, and a MAC header may be used to jointly constitute a data unit of MAC layer.

In another way, the RLC PDU contains the first message header. In this way, the RLC PDU constitutes the data unit of the MAC layer. The data unit of the MAC layer may be a MAC PDU.

Optionally, at least two RLC PDUs in the multiple RLC PDUs correspond to different logical channels, and the at least two RLC PDUs correspond to the same radio bearer.

Therefore, in the method for data transmission according to an implementation of the present disclosure, when sending multiple RLC PDUs, the transmitting end device may include an indication field indicating a radio bearer corresponding to a current RLC PDU in the first message header of at least one RLC PDU in multiple RLC PDUs. Thus the receiving end device may determine a radio bearer corresponding to each RLC PDU in multiple RLC PDUs, thereby realizing a reliable transmission of data.

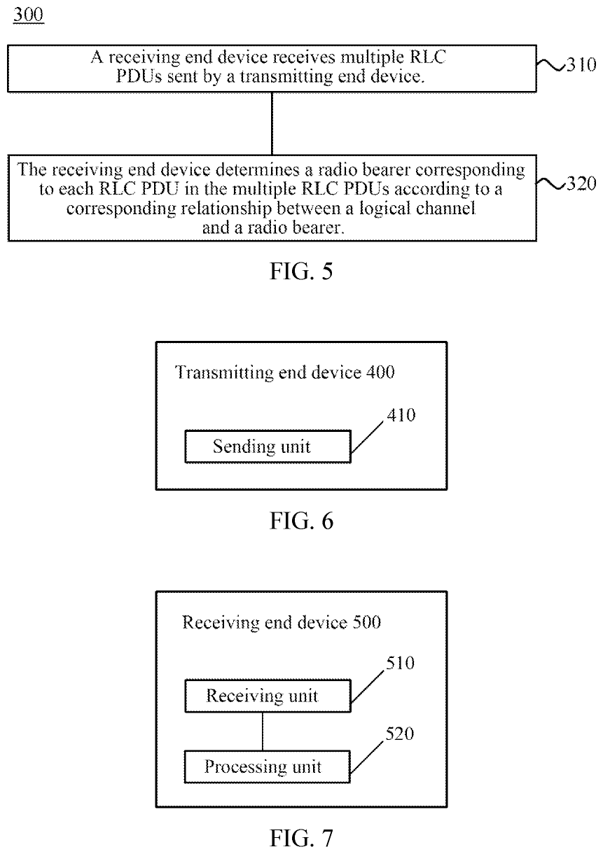

FIG. 5 is a schematic flow chart of a method for data transmission 300 according to an implementation of the present disclosure. As shown in FIG. 5, the method 300 may be performed by a receiving end device, wherein the receiving end device may be a network device as shown in FIG. 1 or a terminal device as shown in FIG. 1 or FIG. 2. A transmitting end device in the method 300 may be a terminal device as shown in FIG. 1 or FIG. 2, wherein the terminal device may perform data transmission as shown in FIG. 3. The method 300 may be applied to a vehicle networking system. The method 300 includes following contents.

In 310, a receiving end device receives multiple RLC PDUs sent by a transmitting end device.

A first message header associated with at least one RLC PDU in the multiple RLC PDUs includes an indication field, wherein the indication field is used for indicating a radio bearer corresponding to the RLC PDU.

At least two RLC PDUs in the multiple RLC PDUs correspond to a first communication system and a second communication system respectively.

In the implementation, the transmitting end device may send at least two RLC PDUs when performing a data duplication service through a carrier aggregation. The transmitting end device may also send at least two RLC PDUs when not performing the data duplication service.

Firstly, a processing mode when transmitting a non-data duplication service is introduced.

At least two RLC PDUs in the multiple RLC PDUs correspond to different transmission formats when the data duplication service is not transmitted. The at least two RLC PDUs correspond to a same radio bearer.

Furthermore, referring to FIG. 3B, when the data duplication service is not transmitted, contents transmitted by at least two RLC PDUs are also different. For example, contents transmitted by at least two RLC PDUs may correspond to serial numbers in different PDCP SDUs. For example, SDU 1 and SDU 3 are the first PDCP PDU, and SDU 2 and SDU 4 are the second PDCP PDU, which are sent to two RLC entities respectively after passing through an RLC layer. The two RLC entities process received PDCP PDUs respectively, transmit them to carrier 1 and carrier 2 through two different MACs to send the first RLC PDU and the second RLC PDU to network device or other terminal device. It should also be understood that a mode for separately transmitting PDCP PDUs to be sent provided in the implementation is only an example, and other division modes may be adopted in actual processing, which are all within a protection scope of the implementation.

Further, the first communication system and the second communication system aforementioned are two different communication systems, which may be a long term evolution LTE system and a new wireless NR system, respectively. Or, they may be other different communication systems, which are not exhaustive here.

Correspondingly, when the first communication system and the second communication system are LTE and NR respectively, the different transmission formats correspond to transmission formats of LTE and NR respectively. That is, when transmitting non-duplicated RLC PDUs, transmission formats corresponding to respective communication systems are adopted for the transmission.

On this basis, when transmitting the data non-duplicated service, the transmitting end device needs to indicate a radio bearer corresponding to a current RLC PDU through an indication field included in the first message header associated with the RLC PDU.

Optionally, the indication field includes an Identity (ID) of a radio bearer corresponding to a PDCP corresponding to the current RLC PDU. The current RLC PDU may be an RLC PDU where the indication field is located.

Optionally, the indication field may also include a logical channel identity.

There may be a further way. A logical channel identity (LCID) and a reserved bit are included in the indication field. Two different logical channels serving a same bearer may be distinguished by assignments of different reserved bits. The specific way is as follows.

Carrier 1: MAC SDU A is transmitted for logical channel A, the reserved bit is set=0 and LCID=X; for example, X=00001.

Carrier 2: another MAC SDU B is transmitted for logical channel B, its reserved bit is set=1 and LCID=X; also, X=00001.

It should be noted that aforementioned logical channels A and B serve a same PDCP entity, but perform a PDCP non-duplication operation. By using the above method, a reserved LCID space may be reserved.

Optionally, the first message header associated with the at least one RLC PDU is:

a first message header corresponding to the at least one RLC PDU, or a first message header contained in the at least one RLC PDU.

The first message header may be an RLC message header.

That is to say, there are two corresponding ways between an RLC PCU and a first message header. One way is that there is a correspondence between an RLC PDU and a first message header, under the correspondence, the RLC PDU may not contain the RLC message header, but the RLC message header is contained outside the RLC PDU. In this case, the RLC message header may constitute a MAC sub-header. In this way, the RLC PDU, the RLC message header constituting the MAC sub-header, and the MAC header, may be used to jointly constitute a data unit of a MAC layer.

In another way, the RLC PDU contains the first message header. In this way, the RLC PDU constitutes the data unit of the MAC layer. The data unit of the MAC layer may be a MAC PDU.

Optionally, at least two RLC PDUs in the multiple RLC PDUs correspond to different logical channels respectively, and the at least two RLC PDUs correspond to the same radio bearer.

Further, a processing mode when transmitting the data duplication service is as follows.

When the data duplication service is not transmitted, optionally, the first message header associated with at least one RLC PDU in the multiple RLC PDUs includes an indication field. The first message header may be an RLC message header.

Optionally, the indication field includes a radio bearer corresponding to the current RLC PDU. The current RLC PDU may be an RLC PDU where the indication field is located.

Optionally, the indication field may also include a logical channel identity.

Optionally, the receiving end device determines a corresponding relationship between the logical channel and the radio bearer according to the indication field included in the RLC message header of the at least one RLC PDU.

Optionally, the indication field may only contain a content of 1 bit. For example, in a protocol, it is specified that 00010 may be only for performing the data duplication service together with 00001, or support a separate bearer. In this case, the indication field may only contain the content of 1 bit to indicate the radio bearer corresponding to the current RLC PDU.

Optionally, the corresponding relationship between the logical channel and the radio bearer is preconfigured, for example, determined by the protocol.

For example, according to a logical channel Identity (LCID) allocation table shown in Table 1 below, 01011-10100 may be allocated from reserved Indexes to an RLC for the data duplication service. For example, Logical channel 00001 and logical channel 01011 will jointly serve a PDCP entity for bearer 1, and logical channel 00010 and logical channel 01100 will jointly serve a PDCP entity for bearer 2.

TABLE 1

| Index | Logical channel identity value |
|---|---|
| 00000 | Reserved |
| 00001-01010 | Logical channel identity |
| 01011-11011 | Reserved |
| 11100 | PC5-S messages that are not protected |
| 11101 | PC5-S messages “Direct Security |
| | Mode Command” and “Direct Security |
| | Mode Complete” |
| 11110 | Other PC5-S messages that are |
| | protected |
| 11111 | Padding |

It should also be noted that optionally, the header associated with the at least one RLC PDU is: an RLC message header corresponding to the at least one RLC PDU; or, an RLC message header contained in the at least one RLC PDU.

That is to say, there may be two corresponding ways between an RLC PCU and an associated first message header.

One way is that there is a correspondence relationship between an RLC PDU and an associated first message header. That is to say, in this relationship, the RLC PDU may not contain the first message header, but the first message header may be contained outside the RLC PDU. In this case, the first message header may constitute a MAC sub-header. In this way, the RLC PDU, the first message header constituting the MAC sub-header, and the MAC header, may be used to jointly constitute a data unit of a MAC layer.

In another way, the RLC PDU contains the first message header. In this way, the RLC PDU constitutes the data unit of the MAC layer. The data unit of the MAC layer may be a MAC PDU.

There may be a further way. A logical channel identity (LCID) and a reserved bit are included in the indication field. Two different logical channels serving a same bearer may be distinguished by assignments of different reserved bits. The specific way is as follows.

Carrier 1: MAC SDU A is transmitted for logical channel A, the reserved bit is set=0 and LCID=X; for example, X=00001.

Carrier 2: another MAC SDU B (which may be understood as a duplicated SDU) is transmitted for logical channel B, its reserved bit is set=1 and LCID=X; also, X=00001.

It should be pointed out that aforementioned logical channels A and B serve a same PDCP entity and realize a PDCP duplication operation. By using the above method, a reserved LCID space may be reserved, and a duplication function may be extended to PC5-S information. Referring to FIG. 10, R represents a position of the reserved bit, one of which is a frame structure containing a 7 bitsL region, and the other is a frame structure containing a 15 bitsL region, which will not be described in detail here.

In 320, the receiving end device determines a radio bearer corresponding to each RLC PDU in the multiple RLC PDUs according to a corresponding relationship between a logical channel and a radio bearer.

Therefore, in the method for data transmission according to an implementation of the present disclosure, when receiving multiple RLC PDUs, the receiving end device may determine the radio bearer corresponding to each RLC PDU in the multiple RLC PDUs according to the corresponding relationship between the logical channel and the radio bearer, thereby realizing a reliable transmission of repeated data.

FIG. 6 is a schematic block diagram of a transmitting end device 400 according to an implementation of the present disclosure. As shown in FIG. 6, the transmitting end device 400 includes a sending unit 410.

The sending unit 410 is configured to send multiple radio link control protocol data units RLC PDUs to a receiving end device.

A first message header associated with at least one RLC PDU in the multiple RLC PDUs includes an indication field, wherein the indication field is used for indicating a radio bearer corresponding to the RLC PDU.

At least two RLC PDUs in the multiple RLC PDUs correspond to a first communication system and a second communication system respectively.

In the implementation, the transmitting end device may send at least two RLC PDUs when performing a data duplication service through a carrier aggregation. The transmitting end device may also send at least two RLC PDUs when not performing the data duplication service.

Firstly, a processing mode when transmitting a non-data duplication service is introduced.

At least two RLC PDUs in the multiple RLC PDUs correspond to different transmission formats when the data duplication service is not transmitted. The at least two RLC PDUs correspond to a same radio bearer.

Furthermore, referring to FIG. 3B, when the data duplication service is not transmitted, contents transmitted by at least two RLC PDUs are also different. For example, contents transmitted by at least two RLC PDUs may correspond to serial numbers in different PDCP SDUs. For example, SDU 1 and SDU 3 are the first PDCP PDU, and SDU 2 and SDU 4 are the second PDCP PDU, which are sent to two RLC entities respectively after passing through an RLC layer. The two RLC entities process received PDCP PDUs respectively, transmit them to carrier 1 and carrier 2 through two different MACs to send the first RLC PDU and the second RLC PDU to a network device or other terminal device. It should also be understood that a mode for separately transmitting PDCP PDUs to be sent provided in the implementation is only an example, and other division modes may be adopted in an actual processing, which are all within a protection scope of the implementation.

Further, the first communication system and the second communication system aforementioned are two different communication systems, which may be a long term evolution LTE system and a new wireless NR system, respectively. Or, they may be other different communication systems, which are not exhaustive here.

Correspondingly, when the first communication system and the second communication system are LTE and NR respectively, the different transmission formats correspond to transmission formats of LTE and NR respectively. That is, when transmitting non-duplicated RLC PDUs, transmission formats corresponding to respective communication systems are adopted for transmission.

On this basis, when transmitting the data non-duplication service, the transmitting end device needs to indicate a radio bearer corresponding to a current RLC PDU through the indication field included in the first message header associated with the RLC PDU.

Optionally, the indication field includes an Identity (ID) of a radio bearer corresponding to a PDCP corresponding to the current RLC PDU. The current RLC PDU may be an RLC PDU where the indication field is located.

Optionally, the indication field may also include a logical channel identity.

There may be a further way. A logical channel identity (LCID) and a reserved bit are included in the indication field. Two different logical channels serving a same bearer may be distinguished by assignments of different reserved bits. The specific way is as follows.

Carrier 1: MAC SDU A is transmitted for logical channel A, the reserved bit is set=0 and LCID=X; for example, X=00001.

Carrier 2: another MAC SDU B is transmitted for logical channel B, its reserved bit is set=1, and LCID=X; also, X=00001.

It should be noted that aforementioned logical channels A and B serve a same PDCP entity, but perform a PDCP non-duplication operation. By using the above method, a reserved LCID space may be reserved.

Optionally, the first message header associated with the at least one RLC PDU is:

a first message header corresponding to the at least one RLC PDU, or a first message header contained in the at least one RLC PDU.

The first message header may be an RLC message header.

That is to say, there are two corresponding ways between an RLC PCU and a first message header. One way is that there is a correspondence between an RLC PDU and a first message header, under the correspondence, the RLC PDU may not contain the RLC message header, but the RLC message header is contained outside the RLC PDU. In this case, the RLC message header may constitute a MAC sub-header. In this way, the RLC PDU, the RLC message header constituting the MAC sub-header, and the MAC header, may be used to jointly constitute a data unit of a MAC layer.

In another way, the RLC PDU contains the first message header. In this way, the RLC PDU constitutes the data unit of the MAC layer. A data unit of the MAC layer may be a MAC PDU.

Optionally, at least two RLC PDUs in the multiple RLC PDUs correspond to different logical channels respectively, and the at least two RLC PDUs correspond to a same radio bearer.

Further, a processing mode when transmitting the data duplication service is as follows.

Optionally, when the data duplication service is not transmitted, the indication field is included in the first message header associated with at least one RLC PDU in the multiple RLC PDUs. The first message header may be an RLC message header.

Optionally, the indication field includes a radio bearer corresponding to the current RLC PDU. The current RLC PDU may be an RLC PDU where the indication field is located.

Optionally, the indication field may also include a logical channel identity.

Optionally, the receiving end device determines a corresponding relationship between the logical channel and the radio bearer according to the indication field included in the RLC message header of the at least one RLC PDU.

Optionally, the indication field may only contain a content of 1 bit. For example, in a protocol, it is specified that 00010 may be only for performing a data duplication service together with 00001, or support a separate bearer. In this case, the indication field may only contain content of 1 bit to indicate the radio bearer corresponding to the current RLC PDU.

Optionally, the corresponding relationship between the logical channel and the radio bearer is preconfigured, for example, determined by a protocol.

For example, according to a logical channel identity (LC ID) allocation table shown in Table 1 below, 01011-10100 may be allocated from reserved Indexes to an RLC serving a data duplication. For example, logical channel 00001 and logical channel 01011 will jointly serve a PDCP entity for bearer 1, and logical channel 00010 and logical channel 01100 will jointly serve a PDCP entity for bearer 2.

TABLE 1

| Index | Logical channel identity value |
|---|---|
| 00000. | Reserved |
| 00001-01010 | Logical channel identity |
| 01011-11011 | Reserved |
| 11100 | PC5-S messages that are not protected |
| 11101 | PC5-S messages “Direct Security |
| | Mode Command” and “Direct Security |
| | Mode Complete” |
| 11110 | Other PC5-S messages that are |
| | protected |
| 11111 | Padding |

It should also be noted that optionally, the header associated with the at least one RLC PDU is: an RLC message header corresponding to the at least one RLC PDU; or, an RLC message header contained in the at least one RLC PDU.

That is to say, there may be two corresponding ways between an RLC PCU and an associated first message header.

One way is that there is a correspondence relationship between an RLC PDU and an associated first message header. That is to say, in this relationship, the RLC PDU may not contain the first message header, but the first message header may be contained outside the RLC PDU. In this case, the first message header may constitute a MAC sub-header. In this way, the RLC PDU, the first message header constituting the MAC sub-header, and the MAC header, may be used to jointly constitute a data unit of a MAC layer.

In another way, the RLC PDU contains the first message header. In this way, the RLC PDU constitutes the data unit of the MAC layer. The data unit of the MAC layer may be a MAC PDU.

There may be a further way. A logical channel identity (LCID) and a reserved bit are included in the indication field. Two different logical channels serving a same bearer may be distinguished by assignments of different reserved bits. The specific way is as follows.

Carrier 1: MAC SDU A is transmitted for logical channel A, the reserved bit is set=0 and LCID=X; for example, X=00001.

Carrier 2: another MAC SDU B (which may be understood as a duplicated SDU) is transmitted for logical channel B, its reserved bit is set=1 and LCID=X; also, X=00001.

It should be pointed out that aforementioned logical channels A and B serve a same PDCP entity and realize a PDCP duplication operation. By using the above method, a reserved LCID space may be reserved, and a duplication function may be extended to PC5-S information. Referring to FIG. 10, R represents a position of the reserved bit, one of which is a frame structure containing a 7 bitsL region, and the other is a frame structure containing a 15 bitsL region, which will not be described in detail here.

Optionally, at least two RLC PDUs in the multiple RLC PDUs correspond to different logical channels, and the at least two RLC PDUs correspond to a same radio bearer.

Optionally, the transmitting end device 400 is applied to a vehicle networking system.

It should be understood that above and other operations and/or functions of various modules in the transmitting end device 400 according to an implementation of the present disclosure are respectively for realizing corresponding procedures of the transmitting end device in the method 200 in FIG. 4, and are not repeated here for the sake of brevity.

FIG. 7 is a schematic block diagram of a receiving end device 500 according to an implementation of the present disclosure. As shown in FIG. 7, the receiving end device 500 includes a receiving unit 510 and a processing unit 520.

The receiving unit 510 is configured to receive multiple radio link control protocol data units RLC PDU sent by a transmitting end device.

The processing unit 520 is configured to determine a radio bearer corresponding to each RLC PDU in the multiple RLC PDUs according to a corresponding relationship between a logical channel and a radio bearer.

It should be understood that above and other operations and/or functions of various modules in the receiving end device 500 according to an implementation of the present disclosure are respectively for realizing corresponding procedures of the receiving end device in the method 300 in FIG. 5, and are not repeated here for the sake of brevity.

FIG. 8 shows a schematic block diagram of a communication device 600 provided by an implementation of the present disclosure. The communication device may be aforementioned transmitting end device or receiving end device, and the device 600 includes: a memory 610, configured to store a program including codes; a transceiver 620, configured to communicate with other devices; and a processor 630, configured to execute program codes in the memory 610.

Optionally, when the codes are executed, the processor 630 may also implement various operations performed by a transmitting end device in the method 200 in FIG. 4, which will not be repeated here for brevity. In the case, the device 600 may be a terminal device, for example, a vehicle-mounted terminal.

Optionally, when the codes are executed, the processor 630 may also implement various operations performed by a receiving end device in the method 300 in FIG. 5, which will not be repeated here for brevity. In this case, the device 600 may be an access network device or a core network device. The transceiver 620 is configured to perform specific transceiving of signals under a driving of the processor 630.

It should be understood that in implementations of the present disclosure, the processor 630 may be a Central Processing Unit (CPU). The processor 630 may also be other general purpose processor, digital signal processor (DSP), application specific integrated circuit (ASIC), Field programmable gate array (FPGA) or other programmable logic device, discrete gate or transistor logic device, discrete hardware component, etc. The general purpose processor may be a microprocessor, or the processor may be any conventional processor, etc.

The memory 610 may include a read-only memory and a random access memory, and provide instructions and data to the processor 630. A portion of the memory 610 may include a non-volatile random access memory. For example, the memory 610 may also store information of device type.

The transceiver 620 may also be configured to implement signal transceiving functions, such as frequency modulation and demodulation functions, or up-conversion and down-conversion functions.

In an implementation process, at least one act of the method may be completed by an integrated logic circuit of hardware in the processor 630, or the integrated logic circuit may complete the at least one act under a driving of instructions in a form of software. Therefore, the device 600 supporting data duplication may be a chip or a chipset. Acts of the method disclosed in connection with implementations of the present disclosure may be directly embodied to be completed by an execution of a hardware processor or by an execution of a combination of hardware and software modules in a processor. The software modules may be located in a storage medium commonly used in the art, such as a random access memory, a flash memory, a read-only memory, a programmable read-only memory or an electrically erasable programmable memory, or a register. The storage medium is located in the memory, and the processor 630 reads the information in the memory and accomplishes the acts of the method with its hardware. In order to avoid repetition, it will not be described in detail here.

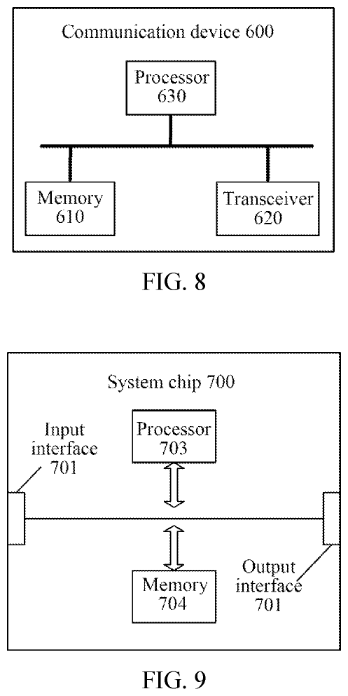

FIG. 9 is a schematic structural diagram of a chip 700 according to an implementation of the present disclosure. The system chip 700 of FIG. 9 includes an input interface 701, an output interface 702, a processor 703 and a memory 704, which may be connected through internal communication connection lines. The processor 703 is configured to execute codes in the memory 704.

Optionally, when the codes are executed, the processor 703 implements a method executed by a transmitting end device in a method implementation. For brevity, details are not described herein again.

Optionally, when the codes are executed, the processor 703 implements a method executed by a receiving end device in a method implementation. For brevity, details are not described herein again.

It should be understood that, the processor in implementations of the present disclosure may be an integrated circuit chip having a signal processing capability. In an implementation process, the acts of the foregoing method implementations may be implemented by using an integrated logic circuit of hardware in the processor or instructions in a form of software. The processor may be a general purpose processor, a digital signal processor (Digital Signal Processing, DSP), an application specific integrated circuit (Application Specific Integrated Circuit, ASIC), a field programmable gate array (Field Programmable Gate Array, FPGA) or another programmable logic device, a discrete gate or a transistor logic device, or a discrete hardware component. Various methods, acts and logical block diagrams disclosed in implementations of the present disclosure may be implemented or performed. The general purpose processor may be a microprocessor, or the processor may be any conventional processor or the like. The acts of the method disclosed with reference to an implementation of the present disclosure may be directly implemented by a hardware decoding processor, or may be implemented by a combination of hardware and software modules in the decoding processor. The software modules may be located in a storage medium commonly used in the art, such as a random access memory, a flash memory, a read-only memory, a programmable read-only memory or an electrically erasable programmable memory, or a register. The storage medium is located in the memory, and the processor reads the information in the memory and completes the acts of the above method in combination with its hardware.

It may be understood that, the memory in an implementation of the present disclosure may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. Through exemplary but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM), and a direct rambus dynamic random access memory (Direct Rambus RAM, DR RAM). It should be noted that the memory in the systems and methods described in this specification is intended to include, but is not limited to, these and any memory of other proper type.

It should be understood that, the foregoing memory is an example for illustration and should not be construed as limitation. For example, optionally, the memory in implementations of the present disclosure may be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), a Direct Rambus RAM (DR RAM), or the like. That is, memories in implementations of the present disclosure are intended to include, but are not limited to, these and any other suitable types of memories.

An implementation of the present disclosure further provides a computer readable storage medium configured to store a computer program.

Optionally, the computer readable storage medium may be applied in a network device of implementations of the present disclosure, and the computer program enables the computer to perform the corresponding processes implemented by the network device in various methods of implementations of the present disclosure. For sake of brevity, it will not be described in detail here.

Optionally, the computer readable storage medium may be applied in a terminal device of implementations of the present disclosure, and the computer program enables the computer to perform the corresponding processes implemented by a mobile terminal/terminal device in various methods of implementations of the present disclosure. For sake of brevity, it will not be described in detail here.

An implementation of the present disclosure also provides a computer program product including computer program instructions.

Optionally, the computer program product may be applied in a network device of implementations of the present disclosure, and the computer program instructions enable the computer to perform the corresponding processes implemented by the network device in various methods of implementations of the present disclosure. For sake of brevity, it will not be described in detail here.

Optionally, the computer program product may be applied in a mobile terminal/terminal device of implementations of the present disclosure, and the computer program instructions enable the computer to perform the corresponding processes implemented by the mobile terminal/terminal device in various methods according to implementations of the present disclosure. For sake of brevity, it will not be described in detail here.

An implementation of the present disclosure also provides a computer program.

Optionally, the computer program may be applied in a network device of implementations of the present disclosure. When the computer program is run on the computer, the computer is enabled to perform the corresponding processes implemented by the network device in various methods of implementations of the present disclosure. For sake of brevity, it will not be described in detail here.

Optionally, the computer program may be applied in a mobile terminal/terminal device of implementations of the present disclosure. When the computer program is run on the computer, the computer is enabled to perform the corresponding processes implemented by the mobile terminal/terminal device in various methods of implementations of the present disclosure. For sake of brevity, it will not be described in detail here.

Those of ordinary skill in the art will recognize that the exemplary elements and algorithm acts described in combination with implementations disclosed herein may be implemented in electronic hardware, or a combination of computer software and electronic hardware. Whether these functions are implemented in hardware or software depends on the specific application and design constraints of the technical solution. Skilled artisans may use different methods to implement the described functions in respect to each particular application, but such implementation should not be considered to be beyond the scope of the present disclosure.

Those skilled in the art may clearly understand that for convenience and conciseness of description, the specific working processes of the systems, apparatuses and units described above may refer to the corresponding processes in the method implementations and will not be described here.

In several implementations provided by the present disclosure, it should be understood that the disclosed systems, apparatuses and methods may be implemented in other ways. For example, the apparatus implementations described above are only illustrative, for example, the division of the units is only a logical function division, and there may be other division manners in actual implementation, for example, multiple units or components may be combined or integrated into another system, or some features may be ignored or not executed. On the other hand, the mutual coupling or direct coupling or communication connection shown or discussed may be indirect coupling or communication connection through some interface, apparatus or unit, and may be in electrical, mechanical or other forms.

The unit described as a separate component may or may not be physically separated, and the component shown as a unit may or may not be a physical unit, i.e., it may be located in one place or may be distributed over multiple network units. Some or all of the units may be selected according to actual needs to achieve the purpose of implementations.

In addition, various functional units in various implementations of the present disclosure may be integrated in one processing unit, or the various units may be physically present separately, or two or more units may be integrated in one unit.

The functions may be stored in a computer readable storage medium if realized in a form of software functional units and sold or used as a separate product. Based on this understanding, the technical solution of the present disclosure, in essence, or the part contributing to the prior art, or the part of the technical solution, may be embodied in the form of a software product stored in a storage medium, including a number of instructions for causing a computer device (which may be a personal computer, a server, or a network device and the like) to perform all or part of the acts of the method described in various implementations of the present disclosure. The foregoing storage medium includes: various media that may store program codes, such as a USB flash drive, a removable hard disk, a read-only memory (Read-Only Memory, ROM), a random access memory (Random Access Memory, RAM), a magnetic disk, or an optical disc.

What are described above are merely exemplary implementations of the present disclosure, but a protection scope of the present disclosure is not limited thereto. Any variation or substitution that may be easily conceived by a person skilled in the art within the technical scope disclosed by the present disclosure shall be included within a protection scope of the present disclosure. Therefore, a protection scope of the present disclosure shall be subject to a protection scope of the claims.

What is claimed is:

1. A method for data transmission, comprising:
sending, by a transmitting end device, a plurality of radio link control protocol data units (RLC PDU) to a receiving end device;
wherein a first message header associated with at least one RLC PDU in the plurality of RLC PDUs contains an indication field, the indication field is used for indicating a radio bearer corresponding to the RLC PDU, and
at least two RLC PDUs in the plurality of RLC PDUs correspond to a first communication system and a second communication system respectively.

2. The method of claim 1, wherein the at least two RLC PDUs in the plurality of RLC PDUs correspond to different transmission formats; contents transmitted by the at least two RLC PDUs in the plurality of RLC PDUs are different; and
the at least two RLC PDUs correspond to a same radio bearer.

3. The method of claim 2, wherein the first communication system and the second communication system are a long term evolution (LTE) system and a new wireless (NR) system, respectively.

4. The method of claim 3, wherein the different transmission formats correspond to a transmission format of LTE and a transmission format of NR respectively.

5. The method of claim 1, wherein the indication field indicates an identity (ID) of a radio bearer corresponding to a packet data convergence protocol (PDCP) corresponding to a current RLC PDU.

6. The method of claim 1, wherein the indication field indicates a logical channel ID.

7. The method of claim 5, wherein the indication field further comprises a reserved bit.

8. A transmitting end device, comprising: a processor and a memory configured to store a computer program that is capable of being run on the processor; wherein the processor is configured to call and run the computer program stored in the memory to
send a plurality of radio link control protocol data units (RLC PDU) to a receiving terminal device;
wherein a first message header associated with at least one RLC PDU in the plurality of RLC PDUs contains an indication field, the indication field is used for indicating a radio bearer corresponding to the RLC PDU; and
at least two RLC PDUs in the plurality of RLC PDUs correspond to a first communication system and a second communication system respectively.

9. The transmitting end device of claim 8, wherein the at least two RLC PDUs in the plurality of RLC PDUs correspond to different transmission formats; contents transmitted by the at least two RLC PDUs in the plurality of RLC PDUs are different; and
the at least two RLC PDUs correspond to a same radio bearer.

10. The transmitting end device of claim 9, wherein the first communication system and the second communication system are a long term evolution (LTE) system and a new wireless (NR) system, respectively.

11. The transmitting end device of claim 10, wherein the different transmission formats correspond to a transmission format of LTE and a transmission format of NR respectively.

12. The transmitting end device of claim 8, wherein the indication field contains an identity (ID) of a radio bearer corresponding to a packet data convergence protocol (PDCP) corresponding to a current RLC PDU.

13. The transmitting end device of claim 8, wherein the indication field comprises a logical channel ID.

14. The transmitting end device of claim 13, wherein the indication field further comprises a reserved bit.

15. The transmitting end device of claim 8, wherein the first message header associated with the at least one RLC PDU is:
an RLC message header corresponding to the at least one RLC PDU.

16. The transmitting end device of claim 8, wherein the first message header associated with the at least one RLC PDU is:
an RLC message header contained in the at least one RLC PDU.

17. The transmitting end device of claim 16, wherein the RLC message header is used for constituting a MAC sub-header.

18. The transmitting end device of claim 8, wherein the at least two RLC PDUs in the plurality of RLC PDUs correspond to different logical channels, and the at least two RLC PDUs correspond to a same radio bearer.

19. The transmitting end device of claim 8, wherein the transmitting end device is applied to a vehicle networking system.

20. A computer readable storage medium, configured to store a computer program, wherein the computer program enables a computer to execute following steps:
sending, by a transmitting end device, a plurality of radio link control protocol data units (RLC PDU) to a receiving end device;
wherein a first message header associated with at least one RLC PDU in the plurality of RLC PDUs contains an indication field, the indication field is used for indicating a radio bearer corresponding to the RLC PDU, and
at least two RLC PDUs in the plurality of RLC PDUs correspond to a first communication system and a second communication system respectively.
